(19) United States
(12) Patent Application Publication
(10) Pub. No.: US 2023/0383902 A1
(43) Pub. Date: Nov. 30, 2023

(54) APPARATUS FOR MOUNTING EQUIPMENT FOR AUDIO-VISUAL APPLICATIONS

(71) Applicant: Matthews Studio Equipment, Inc., Burbank, CA (US)

(72) Inventors: Peter Warren, Ottawa (CA); Martin Torner, Burbank, CA (US); Mohammed Ansari, Burbank, CA (US); Tyler Phillips, Burbank, CA (US)

(21) Appl. No.: 18/225,120

(22) Filed: Jul. 22, 2023

Related U.S. Application Data
(60) Provisional application No. 63/345,877, filed on May 25, 2022.

(51) Int. Cl. F16M 13/02

(52) U.S. Cl. CPC F16M 13/022

(57) ABSTRACT

An apparatus for securely mounting an audio-visual equipment to virtually any external structure is presented. The apparatus includes a base wall with an upwardly extending sidewall on the left and right side, and terminating in outwardly extending flange at the end of each of said sidewall. The base wall includes an aperture at its geometric center for securing a pin or rod. The sidewall includes one or more apertures configured to accept a strap for secure fastening to an external structure. The flange includes one or more apertures configured to accept a screw as an alternate means for secure fastening of the apparatus to the external structure.

The present application claims the benefit of U.S. Provisional Application Ser. No. 63/345,877, filed on May 25, 2022, specification of which is herein incorporated by reference in its entirety.

### BACKGROUND OF THE INVENTION

### Field of the Invention

Embodiments of the invention relates to the field of audio-visual mounting fixtures.

More specifically, the invention relates to an apparatus for mounting various audio-visual equipment.

### Description of the Related Art

Office environments, garages, lofts and other locations have exposed beams or columns that prevent traditional mounting options for lights or other image capture equipment and support gear. This becomes an issue when there is not enough space to facilitate a good shot and/or available equipment does not allow mounted gear to be tucked away and out of frame. Additionally, current mounting solutions may cause damage or discoloration to the location when used improperly to jury-rig a fix.

For instance, grip heads are well known components in the art used in setting up different types of lighting for a film set or photo studio. Thus, grip heads facilitate carrying out a wide range of lighting functions in the audio-visual industry.

A grip head is a versatile component configured to sit on top of light stands, C-stands, or they attach to rigging clamps. They facilitate connecting lighting equipment, such as lights, flags, nets, props, and accessories, via various sized pins and rods, e.g. ⅝-inch and ⅜-inch rods.

Because there are many different types of grip heads to consider, specific audio-visual application requires specialized mounting components that would have to be designed and fabricated at considerable expense to the user.

To overcome the problems and limitations described above there is a need for a cost-effective universal mounting apparatus for practically supporting most audio-visual applications.

### BRIEF SUMMARY OF THE INVENTION

One or more embodiments of the invention is directed to an apparatus for securely mounting an audio-visual equipment to an external structure. The apparatus comprises a base with one or more non-lip foots at its top face. The device further comprises a pin hole (or aperture), preferably at its geometric center, for holding an audio-visual equipment type pin. In one or more embodiments, the pin hole comprises threading that is a female insert configured to accept the male end of various threaded pins, rods, and other A/V mounting gears.

In one or more embodiments, the pin may be secured in place with a threaded bolt that is configured to be hand-operable.

One or more embodiments of the present invention further comprises one or more strap holes (or apertures) that is each configured to accept a strap for securing the base to an external fixture, e.g. a pipe or a building structure component. Each strap hole extends through from the right side to the left side of the base.

One or more embodiments of the present invention, the base may also be configured with one or more screw holes, for optionally securing the base to the external structure with screws. Thus, the base may be secured to the external structure with either one or more straps, one or more screws, or a combination of straps and screws.

In one or more embodiments, the mounting apparatus comprises a base wall. The base wall may be rectangular in shape, for example. The base wall comprises an upwardly extending sidewall on its left and right side, and terminates in outwardly extending flange at the end of each of the sidewall;

In one or more embodiments, the base wall comprises an aperture at its geometric center for securing a pin or rod typically used an audio-visual application, e.g. via grip heads.

In one or more embodiments, each sidewall comprises one or more apertures configured to accept a strap for secure fastening of the device to an external structure.

In one or more embodiments, each flange comprises one or more apertures configured to accept a screw as another option for secure fastening of the device to the external structure.

In one or more embodiments, the aperture at the geometric center of the base wall is threaded as a female receptacle for a male end of a pin or rod.

In one or more embodiments, the one or more apertures on the sidewall comprises one aperture at each end of the sidewall.

In one or more embodiments, the pin or rod comprises a collar at a distal end for securing the pin or rod to the base wall.

In one or more embodiments, the flange comprises a bottom end that is configured to be non-slip via one or more patterns etched or affixed thereon.

### BRIEF DESCRIPTION OF THE DRAWINGS

The above and other aspects, features and advantages of the invention will be more apparent from the following more particular description thereof, presented in conjunction with the following drawings wherein:

FIG. 1 is a perspective view of one embodiment of a universal bracket apparatus P for mounting audio-visual equipment in accordance with the present invention.

FIG. 2 is a perspective view of the universal bracket apparatus of FIG. 1, with a breakout view of the baby pin, in accordance with one or more embodiments of the present invention.

FIG. 3A is a perspective view of a second embodiment of the universal bracket apparatus for mounting audio-visual equipment without a baby pin in accordance with the present invention.

FIG. 3B is a Top plan view of the second embodiment of the universal bracket apparatus in accordance with one or more embodiments of the present invention.

FIG. 3C is a Right Side view of the second embodiment of the universal bracket apparatus in accordance with one or more embodiments of the present invention.

FIG. 3D is a Front view of the second embodiment of the universal bracket apparatus in accordance with one or more embodiments of the present invention.

FIGS. 4A-E are illustrations of different views (A—Perspective; B—Right Side; C—Top; D—Front; and E—Bottom) of the second embodiment of the universal bracket apparatus for mounting audio-visual equipment with a coupled baby pin thereon in accordance with the present invention.

FIG. 5 is an illustration of an exemplary baby pin in accordance with one or more embodiments of the present invention.

FIG. 6 is an illustration of an application of the universal bracket apparatus with a strap in accordance with one or more embodiments of the present invention.

### DETAILED DESCRIPTION

The present invention comprising universal mounting apparatus for equipment used in audio visual applications will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, and ranges in between” can include 1-1, 1-3, 2-10, etc. Similarly, “1, 5, 10, 25, 50, 70, or ranges including and or spanning the aforementioned values” can include 1, 5, 10, 1-5, 1-10, 10-25, 10-95, 1-70, etc.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more embodiments of the present invention will now be described with references to FIGS. 1-5.

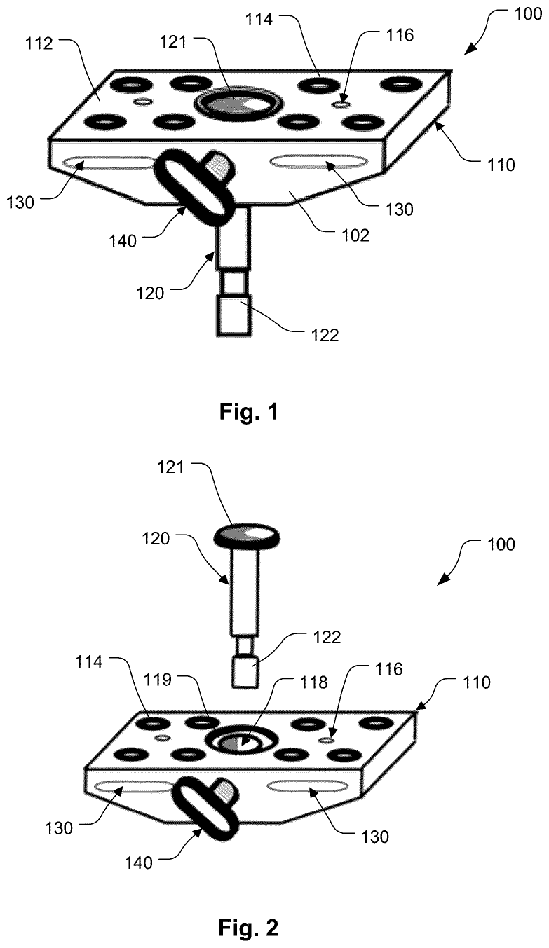

As illustrated in FIGS. 1-2, one or more embodiments of the present invention comprises a universal mounting bracket apparatus 100 for audio-visual and other applications. As illustrated, device 100 comprises a base 110 with one or more non-lip foots 114 at the top face 112. In one or more embodiments, the non-slip foot is a rubber type material. Device 100 further comprises a through hole (or aperture) 118 for securing a drop baby pin, e.g. pin 120. Hole 118 includes a depression 119 configured to act as a shelf to secure the collar (or cap) 121 of drop pin 120, which may be a standard audio-visual pin or rod, for example. In one or more embodiments, hole 118 comprises threading that is a female insert configured to accept various threaded pins, rods, and other standard A/V mounting gears. For example, pins and rods (see FIG. 5) that can be coupled to other A/V equipment via grip heads for the specific application, for example.

One or more embodiments of the present invention further comprises one or more holes (or aperture) 130 that is each configured to accept a strap for securing base 110 to an external fixture, e.g. a pipe or a building structure component. Hole 130 extends from one end of side 102 to the other end (i.e. a through hole from right side to left side). Base 110 may also be secured using screws via one or more holes 116, for example. Thus, base 110 may be secured to the external structure with either one or more straps, one or more screws, or a combination of straps and screws.

In one or more embodiments, drop pin 120 comprises a collar 121 at the distal end and a ridged end 122 for securing an A/V equipment.

In one or more embodiments, base 110 further comprises a screw 140 for securing the pin 120 in a fixed position. Screw 140 may be configured to be hand-tightened, for example.

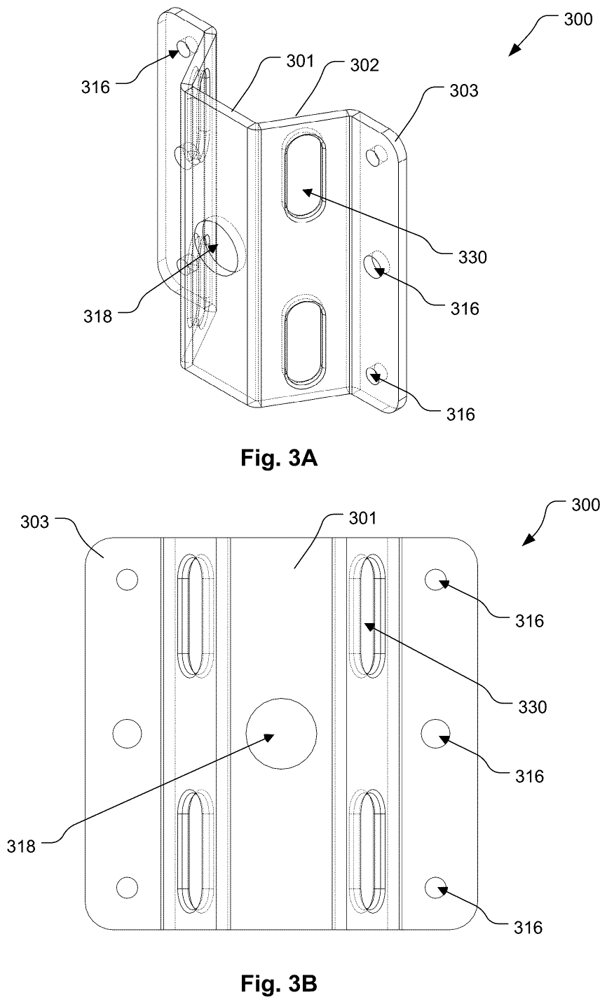

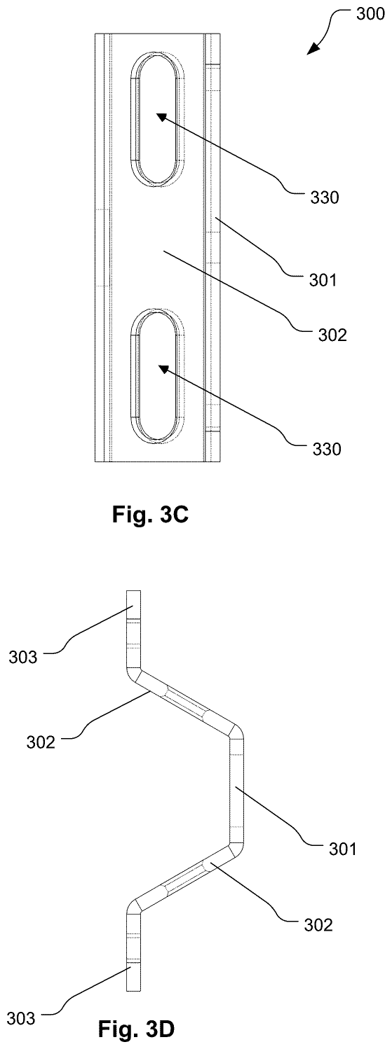

FIGS. 3A-D, are illustrations of various views of another embodiment 300 of the universal mounting apparatus for audio-visual and other applications. As illustrated, device 300 comprises a base wall 301 with an upward extending sidewall 302 on the left and right side, and each sidewall 302 terminating in outward extending flange 303.

Device 300 further comprises a through hole (or aperture) 318 at the geometric center of base wall 301 for securing a pin or rod, e.g. pin 500 in FIG. 5. In one or more embodiments, hole 318 comprises threading that is a female insert configured to accept various male threaded pins, rods, and other standard A/V mounting gears. For example, pins and rods (see FIG. 5) that can be coupled to other A/V equipment via grip heads for the specific application, for example.

One or more embodiments of the present invention further comprises one or more holes (or aperture) 330 on each sidewall 302 that is each configured to accept a strap for securing device 300 to an external fixture, e.g. a pipe or a building structure component. Hole 330 in each sidewall has a corresponding hole on the other sidewall. Device 300 may also be secured to the mounting structure (i.e. external fixture) using screws via one or more holes 316 in flange 303, for example. Thus, device 300 may be secured to the external structure with either one or more straps, one or more screws, or a combination of straps and screws. Note that screw holes 316 are not necessary if the device is to be secured with one or more straps.

In one or more embodiments, device 300 comprises one or more straps (not shown) are fixedly coupled to said device 300 for securing device 300 to the external structure.

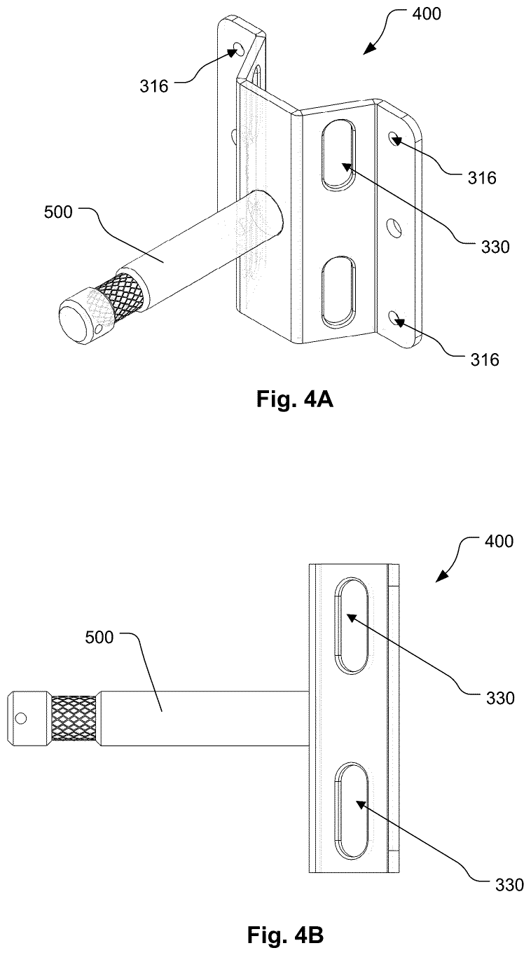

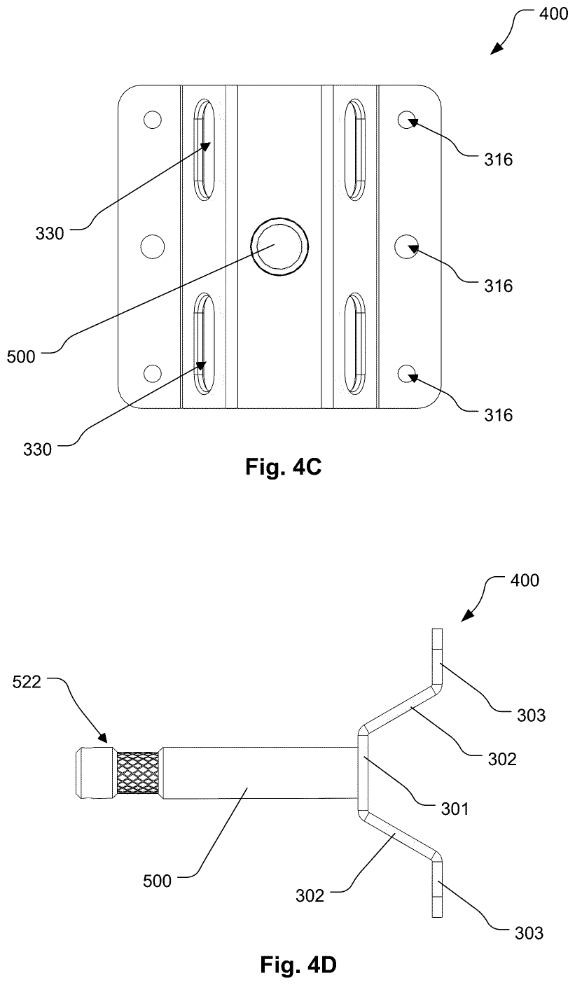

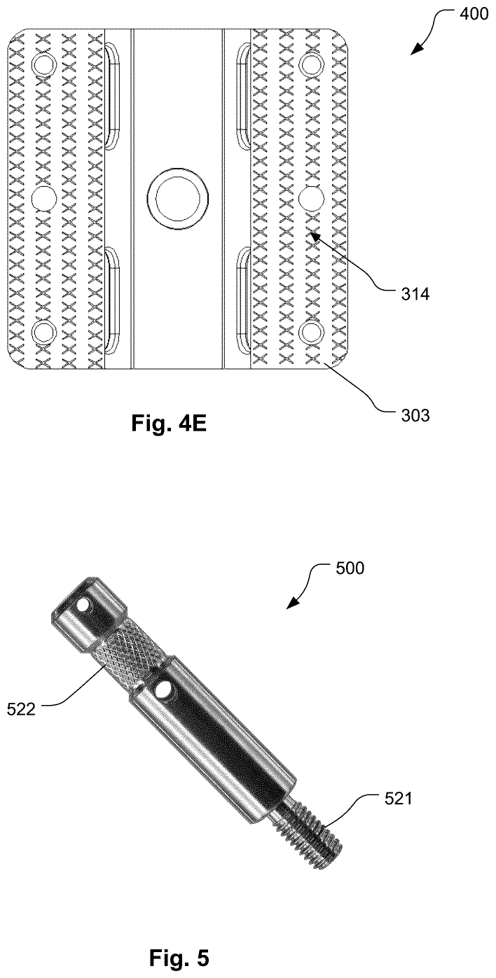

In one or more embodiments, the bottom side of flange 303 may be configured to be non-slip, e.g. with one or more patterns etched or affixed therein, as illustrated in FIG. 4E.

FIGS. 4A-E, are illustrations of various views of embodiment 300 of the universal mounting apparatus with a pin 500 secured therein. As illustrated, pin 500 is securely coupled to device 300 via orifice 318, with the A/V equipment mounting end 522 of pin 500 disposed on the top side of the device 300.

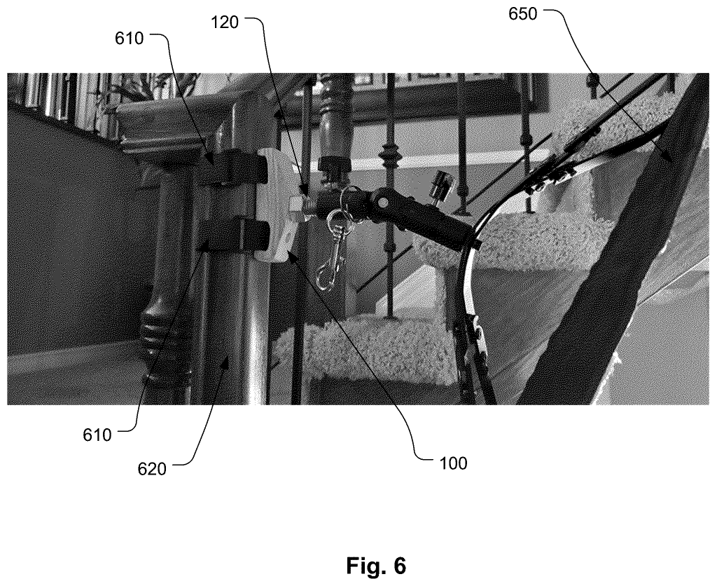

One or more embodiments of the present invention further comprises one or more straps, e.g. 610, for securing the mounting bracket to an external fixture, e.g. a fluid pipe or a building structure (e.g. staircase foot 620) as illustrated in FIG. 6. As illustrated in FIG. 6, the mounting bracket 100 is secured to the foot 620 of the staircase via the straps 610. The A/V equipment, e.g. 650, is then secured to end 122 of pin 120.

While the invention herein disclosed has been described by means of specific embodiments and applications thereof, numerous modifications and variations could be made thereto by those skilled in the art without departing from the scope of the invention set forth in the claims.

What is claimed is:

1. A mounting apparatus comprising:
a base wall having a left side and a right side, said base wall having an upwardly extending sidewall on said left side and said right side, and terminating in an outwardly extending flange at the end of each of said sidewall;
the base wall comprises an aperture at its geometric center for securing a pin or rod;
said sidewall comprises one or more apertures configured to accept a strap for secure fastening to an external structure; and
said flange comprises one or more apertures configured to accept a screw for secure fastening to said external structure.

2. The mounting apparatus of claim 1, wherein said aperture at the geometric center of the base wall is threaded as a female receptacle for a male end of a pin or rod.

3. The mounting apparatus of claim 1, wherein said one or more apertures configured to accept a strap comprises one aperture at each end of said sidewall.

4. The mounting apparatus of claim 1, wherein said pin or rod comprises a collar at a distal end for securing said pin or rod to the base wall.

5. The mounting apparatus of claim 1, wherein a bottom end of said flange is configured to be non-slip via one or more patterns etched or affixed thereon.

6. A mounting apparatus comprising:
a rectangular base wall with an upwardly extending sidewall on its left and right sides, and terminating in outwardly extending flange at the end of each of said sidewall;
the base wall comprising an aperture at its geometric center for securing a pin or rod;
said sidewall comprising one or more apertures configured to accept a strap for secure fastening to an external structure; and
said flange comprising one or more apertures configured to accept a screw for secure fastening to said external structure.

7. A mounting apparatus comprising:
a rectangular base wall with an upwardly extending sidewall on its left and right sides, and terminating in outwardly extending flange at the end of each of said sidewall;
the base wall comprising an aperture at its geometric center for securing a pin or rod;
said sidewall comprising one or more straps for secure fastening to an external structure; and
said flange comprising one or more apertures configured to accept a screw for secure fastening to said external structure.
